(19) United States
(12) Patent Application Publication
(10) Pub. No.: US 2010/0228594 A1
(43) Pub. Date: Sep. 9, 2010

(54) ADVERTISING AND PROMOTIONAL SYSTEM

(76) Inventors: Mark Chweh, San Diego, CA (US); Darrius Thompson, Cardiff, CA (US); Blake Machado, Long Beach, CA (US); Matthew Meredith, Santa Monica, CA (US); Chester NG, San Diego, CA (US); Adrian Bourke, San Diego, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/398,136

(22) Filed: Mar. 4, 2009

(51) Int. Cl. G06Q 30/00; G06F 9/445; G06Q 99/00

(52) U.S. Cl. 705/10; 717/178; 705/27; 705/30; 705/26; 705/14.41

(57) ABSTRACT

Advertising networks are described that enable the provision of offers to a user device in response to activation of an installation package. One embodiment of the invention includes a user device connected to a network, an advertising server system connected to the network, where the advertising server system stores information concerning a plurality of offers, and a partner server connected to the network. In addition, the user device is configured to execute an installation package to perform a predetermined operation, where the execution of the installation package triggers execution of a client application configured to collect information concerning the user device and to forward the collected information to the advertising server system as the installation package performs the predetermined operation, the advertising server system is configured to select at least one of the plurality of offers based upon the collected information and to forward information concerning the at least one selected offer to the client application, the client application is configured to display via the user device information concerning the at least one selected offer as the installation package performs the predetermined operation, and the client application is configured to contact the partner server to obtain fulfillment of an accepted offer.

### BACKGROUND

The present invention relates generally to advertising and promotional systems and more specifically to advertising and promotional systems that present offers to users during the installation of a software application.

Advertising and promotional systems are frequently used as revenue generation methods by websites, software, Internet services, cell phone services and many other consumer and business oriented offerings. Potential profits are based on various performance factors such as ratio of offers accepted to offers presented, total number of offers presented, geographic location of audience, and other similar data points. This method of profit generation is frequently plagued by very low acceptance rates. Given small acceptance statistics, a very large number of offer presentations must be made in order to generate meaningful profits. In addition, fairly complex business agreements must be forged in order to take benefit from these types of revenue sources. Many smaller organizations do not have the proper types of human resources or the experience needed to negotiate these types of agreements. While many different types of potential offers exist it is often hard to predict which offer(s) will be profitable to engage with. Complexity in integrating offers with existing applications, costs in distributing software, development expenses for gathering data, and difficulty with targeting offers often precludes the use of more than one offer deal by a specific organization.

### SUMMARY OF THE INVENTION

Advertising networks in accordance with embodiments of the invention present offers to users that execute an installation package. One embodiment of the invention includes a user device connected to a network, an advertising server system connected to the network, where the advertising server system stores information concerning a plurality of offers, and a partner server connected to the network. In addition, the user device is configured to execute an installation package to perform a predetermined operation, where the execution of the installation package triggers execution of a client application configured to collect information concerning the user device and to forward the collected information to the advertising server system as the installation package performs the predetermined operation, the advertising server system is configured to select at least one of the plurality of offers based upon the collected information and to forward information concerning the at least one selected offer to the client application, the client application is configured to display via the user device information concerning the at least one selected offer as the installation package performs the predetermined operation, and the client application is configured to contact the partner server to obtain fulfillment of an accepted offer.

In a further embodiment, the installation package includes an installer, a payload application and the client application, and the predetermined operation includes the application of the payload application to the user device.

In another embodiment, the client application is bundled in the installation package and the installer activates the client application via an adaptor.

In a still further embodiment, the client application is integrated with the installer.

In still another embodiment, the client application is integrated with the payload application.

A yet further embodiment also includes a download server, where the installation package is stored. In addition, the user device downloads the installation package from the download server.

In yet another embodiment, the predetermined operation includes a service signup.

In a further embodiment again, the predetermined operation is the display of media.

In another embodiment again, the information collected by the client application includes data descriptive of the user device.

In a further additional embodiment, the information collected by the application includes information concerning at least one of the capabilities of the device, the configuration of the device, software present on the device, software absent from the device, device operating system type, and device operating system configuration.

In another additional embodiment, the information collected by the client application also includes data descriptive of the user of the user device.

In a still yet further embodiment, the information collected by the application includes at least one of user language setting, user identification, and services available to the user.

In still yet another embodiment, the information collected by the client application includes the geographic location of the user device.

In a still further embodiment again, the installation package includes validation information, the client application is configured to provide the validation information to the advertising server system, and the advertising server system is configured to verify the validation information before providing offers to the client application.

In still another embodiment again, the validation information includes information identifying the publisher of the installation package.

In a still further additional embodiment, the validation information includes a software signature.

In still another additional embodiment, the installation package includes information identifying the publisher of the installation package, the advertising server system maintains an account with respect to the publisher of the installation package, the client application is configured to provide the information identifying the publisher of the installation package to the advertising server system, and the advertising server system credits the account of the publisher when an offer provided to the user device by the advertising server system is accepted.

In a yet further embodiment again, the user device is a personal computer.

In yet another embodiment again, the user device is a mobile phone handset.

In a yet further additional embodiment, the client application is part of the firmware of the mobile phone handset.

In yet another additional embodiment, wherein the user device is a set top box connected to a display.

In a further additional embodiment again, the client application is part of the firmware of the set top box.

In another additional embodiment again, the partner server is part of the advertising server system.

Another further embodiment includes a user device connected to a network, a download server connected to the network, where the download server stores an installation package that contains an installer, a payload application, and a client application and the installation package is configured to install the payload application on the user device, an advertising server system connected to the network, where the server system stores information concerning a plurality of offers, and a partner server connected to the network. In addition, the user device is configured to obtain the installation package from the download server and execute the installer to install the payload application, the installer is configured to execute the client application during the installation of the payload application, the client application is configured to forward the installation package validation information to the advertising server system, the advertising server system is configured to validate the installation package and identify the publisher of the installation package using the installation package validation information, the advertising server system is configured to select at least one of the plurality of offers and to forward information concerning the at least one selected offer to the client application, the client application is configured to display via the user device information concerning the at least one selected offer during the installation of the payload software application, the client application is configured to contact the partner server to obtain fulfillment of an accepted offer, and the advertising server system is configured to update an account maintained concerning the publisher of the installation package to reflect the fulfillment of the accepted offer.

In still another further embodiment, the partner server is part of the advertising server system.

In yet another further embodiment, the client application is bundled Within the installation package and the installer activates the client application via an adaptor.

Another further embodiment again includes downloading an installation package to a user device, where the installation package includes an installer, a payload application, and a client application, executing the installer, where the installer applies the payload application to the user device and executes the client application, forwarding installation package validation information to an advertising server system using the client application, selecting at least one from a plurality of offers stored on the advertising server system in response to the verification of the installation package validation information, providing the at least one offer to the client application, presenting the at least one offer to a user via the user device, receiving acceptance of at least one of the offers via the user device, and requesting fulfillment of the offer using the client application.

In another further additional embodiment, the client application is bundled within the installation package and the installer activates the client application via an adaptor.

Still yet another further embodiment also includes collecting information from the user device using the client application, and forwarding the collected information to an advertising server system using the client application. In addition, the at least one of the plurality of offers is selected based upon the collected information.

### BRIEF DESCRIPTION OF THE DRAWINGS

FIG. 1 is a semi-schematic diagram of an advertising network in accordance with an embodiment of the invention.

FIG. 2 is a flow chart showing a process for providing an offer to a user installing a piece of software in accordance with an embodiment of the invention.

FIG. 3 is a semi-schematic diagram of the stack of a client application in accordance with an embodiment of the invention.

FIG. 4 is a semi-schematic diagram of software modules included on servers in an advertising network in accordance with an embodiment of the invention.

FIG. 5 is a flow chart showing communication between a client application and various servers in the presentation and fulfillment of offers during a software installation in accordance with an embodiment of the invention.

FIG. 6 is a flow chart showing communication between a client application and servers in an advertising network during installation of a software application in accordance with an embodiment of the invention.

FIG. 7 is a flow chart showing communication between a client application and servers in an advertising network during offer acceptance in accordance with an embodiment of the invention.

FIG. 8 is a flow chart showing communication between a client application and servers in an advertising network during the tracking of an offer acceptance in accordance with an embodiment of the invention.

### DETAILED DESCRIPTION OF THE INVENTION

Turning now to the drawings, advertising networks that present offers to users that execute an installation package in accordance with embodiments of the invention are shown. When a user installs an installation package, a client application bundled with the installation package communicates with a server system to coordinate the provision of offers to the user. An installation package can be software, firmware, a web application and/or other form of execution instructions that apply new software or firmware to a user device, update existing software or firmware, perform a service signup, display media, and/or execute a similar operation on a user device. The offers provided to the user can include advertisements, audio and/or media, software installations, linking to a web site, provision of a web service, or any other type of presentation that can be displayed, viewed or executed on the user device. In many embodiments, publishers can publish an installation package and derive revenue from the advertising network without the need to develop individual advertising agreements with advertisers. In several embodiments, offers provided by the advertising network to a user via a publisher's installation package are selected to maximize the revenue generated by the publisher. In a number of embodiments, offers are selected according to criteria including, but not limited to, the offers most likely to be accepted by users of a publisher's installation package, offers a publisher chooses to provide and/or other criteria designed to provide users with useful recommendations and/or generate revenue.

In a number of embodiments, the offers provided to a user by the advertising network are customized according to information ascertained by the client application and/or the server system concerning the user and/or the user device. In several embodiments, the advertising network tracks offers provided to users and user responses to offers. In many embodiments, the server system validates installation packages, user devices and/or users so that publishers can supervise the use of the installation packages and so that advertisers are provided with assurance that offers are presented to and accepted by legitimate users.

### Advertising Network Architecture

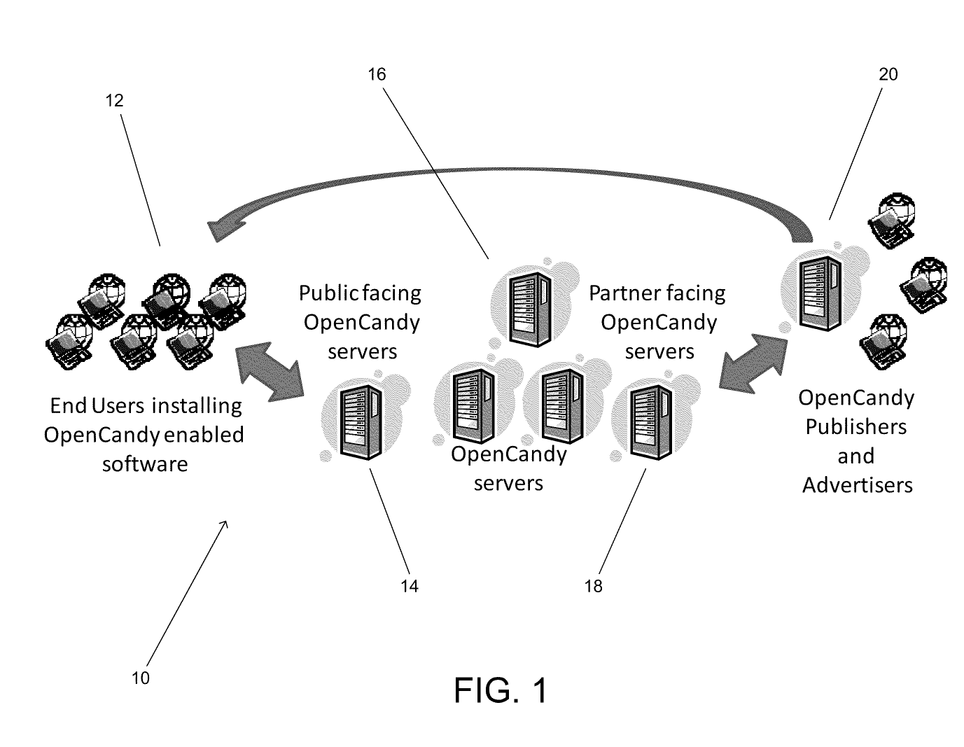

An advertising network in accordance with an embodiment of the invention is illustrated in FIG. 1. The advertising network 10 includes client applications 12 that can be executed on user devices. In a number of embodiments, the client applications are related to installation packages. When each installation package is executed, the client application is activated and coordinates communication with a server system via a network. In the illustrated embodiment, the client applications 12 communicate with public facing servers 14. In many embodiments, the client application examines the user device and gathers information concerning the user and/or the user device. The client application provides the collected information to the public facing servers 14. The public facing servers 14 communicate with internal servers 16 to determine one or more offers that can be presented to the user by the client application. The public facing servers 14 communicate the one or more offers to the client application and the client application presents the one or more offers to the user via the user device. In many embodiments, a database of offers from software publishers and advertisers is maintained by the internal servers 16 and the internal servers attempt to match offers to users based upon information collected by the client applications. In several embodiments, partner facing servers 18 provide an interface via which publishers and advertisers can upload offers to the offer database.

A user can utilize the client application 14 to accept an offer presented to the user by the client application. Often, fulfillment of the offer requires communication with a partner server 20 that is maintained by the partner entity that engaged the advertising network to distribute the offer. In the illustrated embodiment, the client application 12 communicates directly with the partner server 20 to obtain fulfillment of an accepted offer. In other embodiments, the advertising network's server system coordinates fulfillment of the offer.

### Installation Packages

An installation package can be software, firmware, a web application and/or other form of execution instructions that apply new software or firmware to a user device. A typical installation package for applying new software to a user device includes an installer, and an application to be installed (payload application). The installer performs operations that can install the payload application to the user device. In many instances, the installer is specifically written to install a particular payload application contained in the installation package. However, many installers are general-purpose and the installation package includes instructions or scripts that provide directions to the general-purpose installer concerning the manner in which a payload application is to be applied to a user device. Examples of general-purpose installers that can be used to create installer packages for applying new software to a user device include the Nullsoft Scriptable Install System (NSIS) installer distributed by Nullsoft, the InstallShield installer distributed by Acresso Software Inc., the MSI installer distributed by Microsoft Corporation, SetupFactory distributed by Indigo Rose Corporation and the Inno Setup installer developed by Jordan Russell and Martijn Laan and distributed via the website located at http://www.InnoSetup.com. In other embodiments, the installation package updates existing software or firmware, performs a service signup, displays media, and/or executes an operation on the user device.

As discussed above, installation packages in accordance with embodiments of the invention can include a client application that connects to the advertising network and provides offers to a user. The client application can be bundled with the installation package, integrated within the installer and/or integrated within a payload application. In many instances, the client application is included in the installation package so that the publisher of the installation package can generate revenue by providing offers to users. In several embodiments, publishers can create installation packages that include a client application using tools provided by the advertising network and a general-purpose installer.

In many scenarios, the same client application can be used with a number of different general-purpose installers using adaptors. The adaptors are typically written in the scripting language of the installer (although can include executable code). In several embodiments, the client application supports a number of Application Programming Interface (APIs) that are used by the adapter to interface the installer with the client application. A client application in accordance with an embodiment of the invention developed for use with one or more variants of the Windows operating system distributed by Microsoft Corporation implements the client application as a Dynamic Link Library (DLL) including a number of APIs. In circumstances where an adaptor is not provided to integrate an installer with the client application, the installer can be directly integrated with the DLL.

Installation packages can be deployed using a variety of deployment mechanisms, including transitory means such as temporary transmission via electronic methods via the Internet, longer term methods such as software stored in device firmware or other device storage media, and data or executables copied to traditional fixed media such as CD-ROM and DVD. The deployment of installation packages, and execution of client applications in the provision of offers to users is discussed further below.

### Provision of Offers

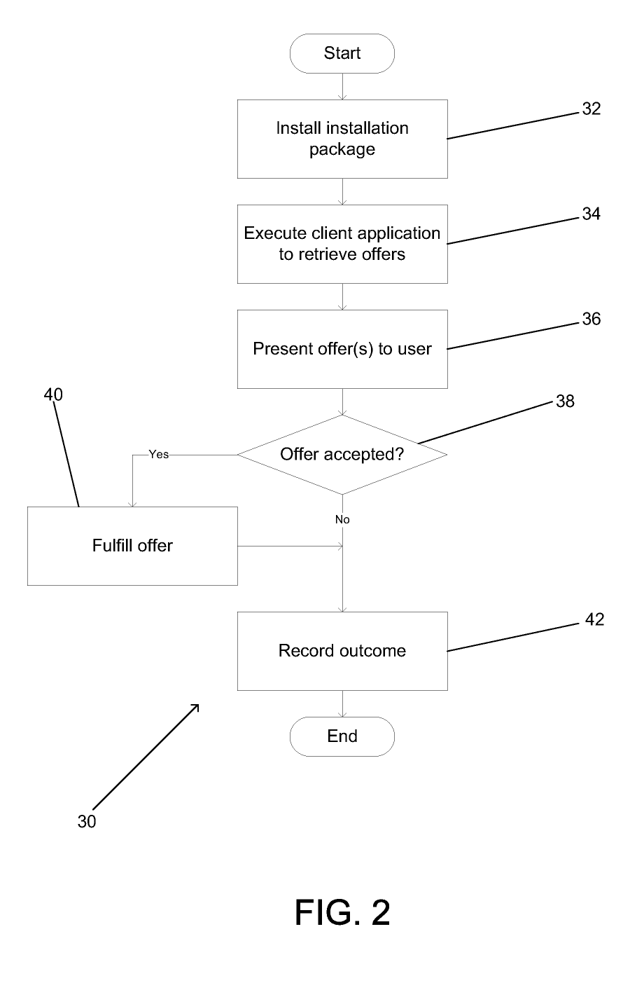

A process used by an advertising network to provide offers to a user executing an installation package in accordance with an embodiment of the invention is shown in FIG. 2. The process 30 includes executing (32) an installation package, which results in the execution (34) of a client application. The client application retrieves offers from the server system and presents (36) the offers to the user. A determination (38) is made as to whether the user has accepted any of the offers. In the event that an offer is accepted, the offer is fulfilled (40). Irrespective of whether the offer is accepted, the outcome of the presentation of offers to the user is recorded (42).

### User Devices and Client Applications

Advertising networks in accordance with embodiments of the invention utilize client applications present on user devices in order to distribute offers to users. User devices in accordance with embodiments of the invention include personal computers, consumer electronics devices, telephones and/or any other type of device that can communicate with a remote server via the Internet. The client application can be software, firmware, a transitory web application and/or any other form of execution instructions that can be performed on the user device.

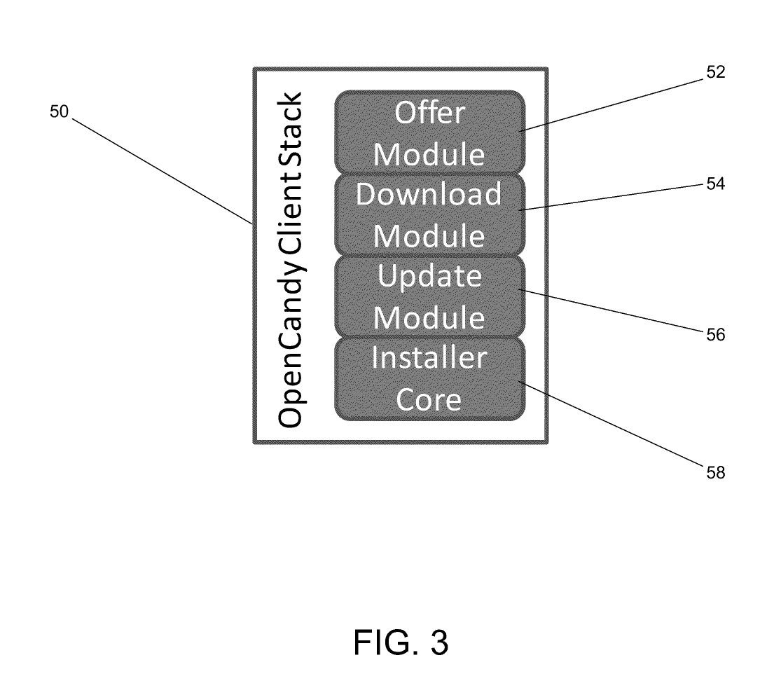

Components of a client application in accordance with an embodiment of the invention are shown in FIG. 3. The client application software 50 includes an offer module 52, a download module 54, an update module 56, and an installer core module 58. The operation of each of the modules is discussed below with reference to examples of various operations that can be performed by an advertising network in accordance with embodiments of the invention.

The reusabitity/adaptabitity of the client application enables any publisher, including smaller publishers, to derive revenue from the presentation of offers to users, who download the installation package. A small publisher can obtain access to advertising revenue by simply including the client application within the publisher's installation package. In many instances, the inclusion of the client application in an installation package can be achieved using tools provided by the advertising network. The publisher need not independently secure advertising agreements or create an installation package capable of presenting and fulfilling offers.

### Server System

Advertising networks in accordance with embodiments of the invention can be implemented using any number of server configurations. In the embodiment illustrated in FIG. 1, the functions of the server system are separated into three server clusters: the public facing servers, the internal servers and the partner facing servers. In other embodiments, other architectures for the server system can be utilized.

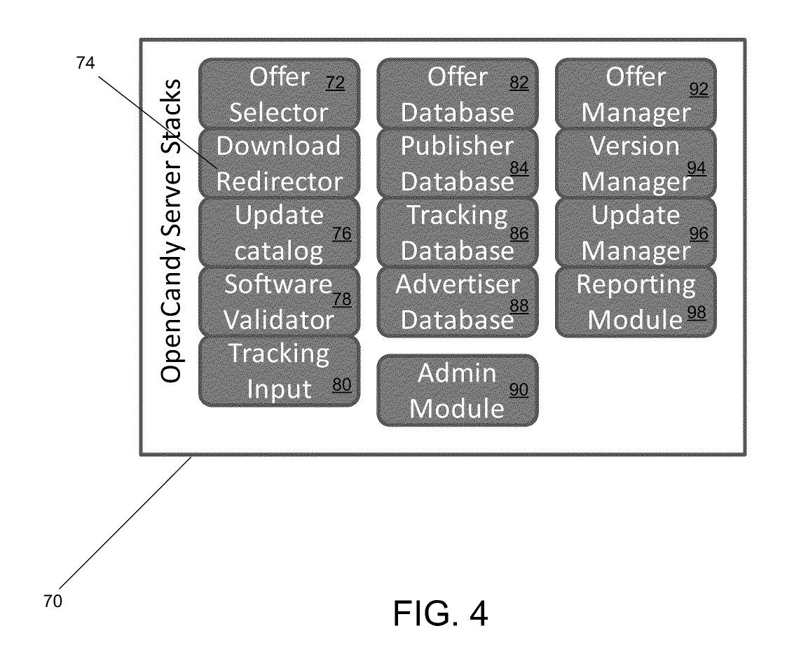

Software modules present in a server system in accordance with an embodiment of the invention are shown in FIG. 4. The software system 70 includes an offer selector module 72, a download redirector module 74, an update catalog module 76, a software validator module 78, a tracking input module 80, an offer database 82, a publisher database 84, a tracking database 86, an advertiser database 88, an admin module 90, an offer manager 92, a version manager 94, an update manager 96, and a reporting module 98. The operation of each of the modules is discussed below with reference to examples of various operations that can be performed by an advertising network in accordance with embodiments of the invention.

### Operation of Advertising System

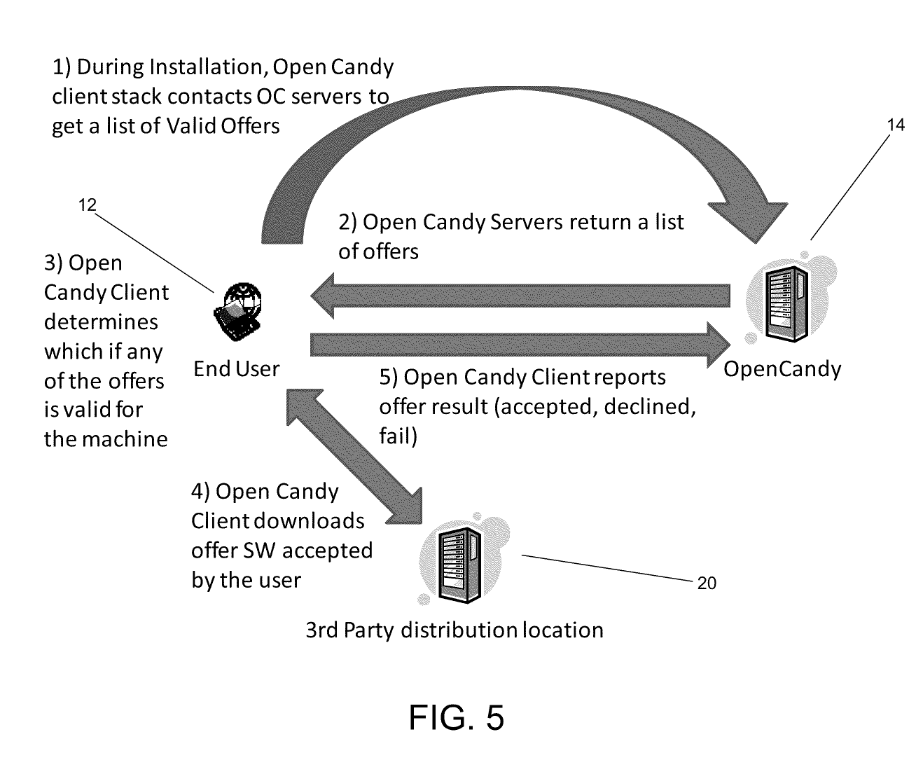

Communication between a client application, a server system and a partner server in accordance with an embodiment of the invention is shown in FIG. 5. During execution of an installation package, the client application is executed and the client application 12 contacts the server system (in this case a public facing server 14) to obtain a list of valid offers. As part of the initial execution, the client application can utilize a display on the user device to notify the end user of terms of use, rights granted or restricted, and other legal or procedural disclosures. The client application can also examine the user device for information about the device and/or user to provide to the server system to enable the customization of offers. In several instances, the client application interacts with the user to obtain additional information. In many instances the type of information depends upon the nature of the user device and the specific application. The process of collecting information is discussed further below.

A list of valid offers is provided to the client application 12 via the server system. The server system can execute various algorithms to determine which offer(s) are best suited to the user and the user device. These algorithms may take into account, but are not limited to, targeting information gathered by the client application, targeting information gathered by the server system, manually defined preferences, statistical measures of offer success rate, random selection, and/or other factors. In the absence of network connectivity, the client application can simply select from a default list of offers maintained locally within the installation package and/or suspend presentation of offers until the device is connected. In many embodiments, the publisher can select offers (e.g. other applications or upgrades) that provide the user with recommendations that compliment the installation package.

The client application 12 determines which of the offers are valid for the user device on which the client application is executing. When a user accepts one of the offers, the client application can communicate with the partner server 20 to complete the offer. In embodiments where the offer is to download a piece of software provided by the partner, the client application contacts the partner server and downloads the offered software for installation on the user device. In a number of embodiments, the server system also possesses the capacity to fulfill offers (e.g. the server system hosts partner software downloads) and the client application can communicate with the server system to fulfill the offer.

Data from the various stages of the above process is collected and stored by the server system. The data can be used to track offer performance, track which installation packages initiated client application interaction, analyze system performance, and augment the data inputs to the server system offer selection algorithms. During offer presentation, many embodiments collect data in conjunction with the presentation of offers including but not limited to user acceptance or refusal, decision influencing factors, early termination of the presentation and other points of data. Tracked data can be processed in the performance of accounting operations. In a number of embodiments, trending analysis, revenue projections, performance data, and other relevant business statistics are prepared and fed into a report system. In other embodiments, other financial information and/or reports are generated in accordance with the needs of specific partners and/or applications. Once financial operations have been performed, revenues can be calculated and distributed to publishers as dictated by contractual terms.

During operation of the advertising network, an advertiser can enter or modify system settings via the partner facing servers. Such settings may include, but are not limited to, the following: offer preference weighting, offer inclusion or exclusion per subscriber project, geographic based offer inclusion or exclusion per subscriber project, offer presentation style, subscriber project version information, and distribution preferences/locations.

### Information Flow

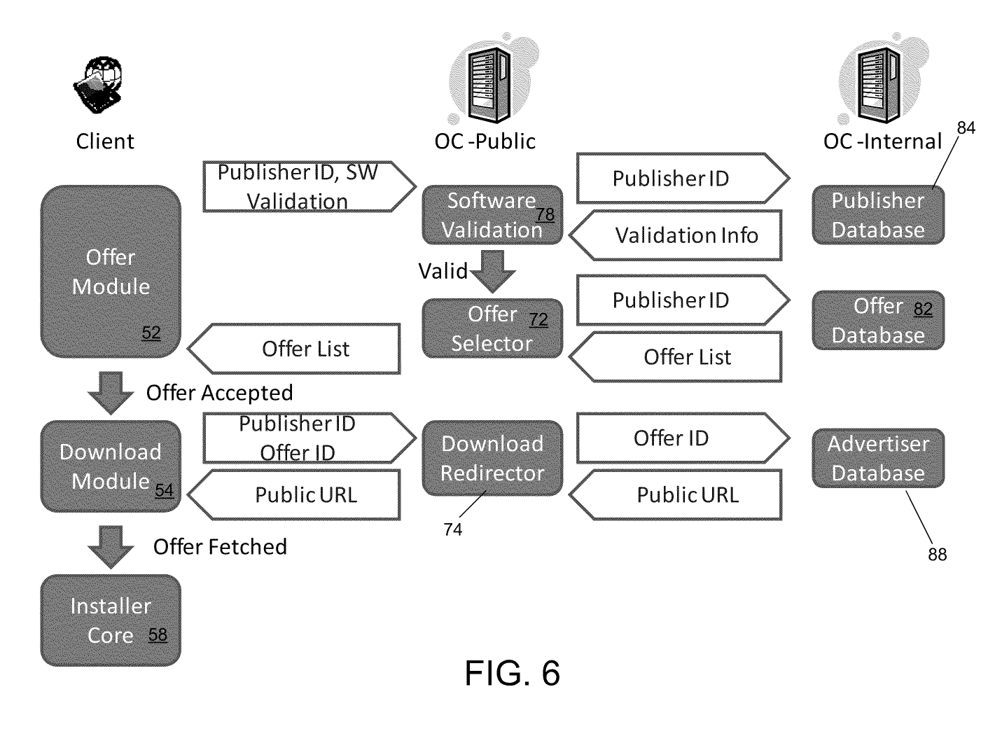

Information flow within an advertising network as an offer is presented to a user and accepted in accordance with an embodiment of the invention is shown in FIG. 6. The offer module 52 enables a client application to validate the installation package being installed by the user, to obtain offers to present to the user, and to track the offers provided to the user and any offers accepted by the user. In the illustrated embodiment, the offer module 52 provides a publisher ID and software validation information to a public facing server. The software validator module 78 accesses a publisher database located on an internal server to validate the installer package using the publisher ID and the software validation information. In a number of embodiments, the software validation information includes a software signature. In other embodiments, the advertising network incorporates other security features in accordance with the security needs of the application.

Once the installation package is validated, an offer selection module 72 on the public facing server communicates with the offer database 82 located on an internal server to select offers to provide to the user. In the illustrated embodiment, the offer database 82 uses the publisher ID to select offers to provide to the user. In a number of embodiments, the client application collects target information from a user device and/or from interrogating the user and communicates the target information to the public facing server. The internal server can use the target information to select offers. Target information can be data that is collected, calculated, or manually programmed that is used to match an end user to a set of offers in order of preference within the system. Target information can include, but is not limited to, data such as geographic location, device capabilities, user's language settings, device configuration, software present on the device, operating system type and configuration, records of offers previously presented on the device or to the user, user identification or anonymous status, software absent from the device, services available to the user and/or device, demographics, and other types of descriptive data which describe the end user and the device.

Once an offer list has been created, the offer list is communicated to the offer module 52 in the client application by the offer selection module 72 of the public facing server. If the offer list has not already been filtered by the server system, the offer module 72 can filter the offer list to ensure that the offer list only contains offers that are valid for the particular user device on which the client application is installed.

When a user accepts one of the offers, the download module 54 provides the publisher ID and the offer ID to the public facing server. The download redirector module 72 on the public facing server provides the offer ID to an advertising database 88 maintained on an internal server. The advertising database provides a public URL to the download redirector and the public facing server provides the public URL to the download module 54 of the client application. The client application then uses the public URL to fulfill the offer. Once the offer has been fulfilled, the installer core module 58 performs the installation that is the heart of the installation package. In many instances, the installation is the application of a payload application to the user device. In other applications, the installation package can involve performing a service signup displaying media, and/or executing an operation on the user device

Although the information flow shown in FIG. 6 is described with reference to a specific advertising system architecture, similar information flows can be coordinated using other architectures. For example, a similar information flow can be coordinated in a system that uses a different server system architecture such as an architecture where the various databases are hosted on separate internal servers and/or the databases are configured as a single database.

### Filtering of Offers

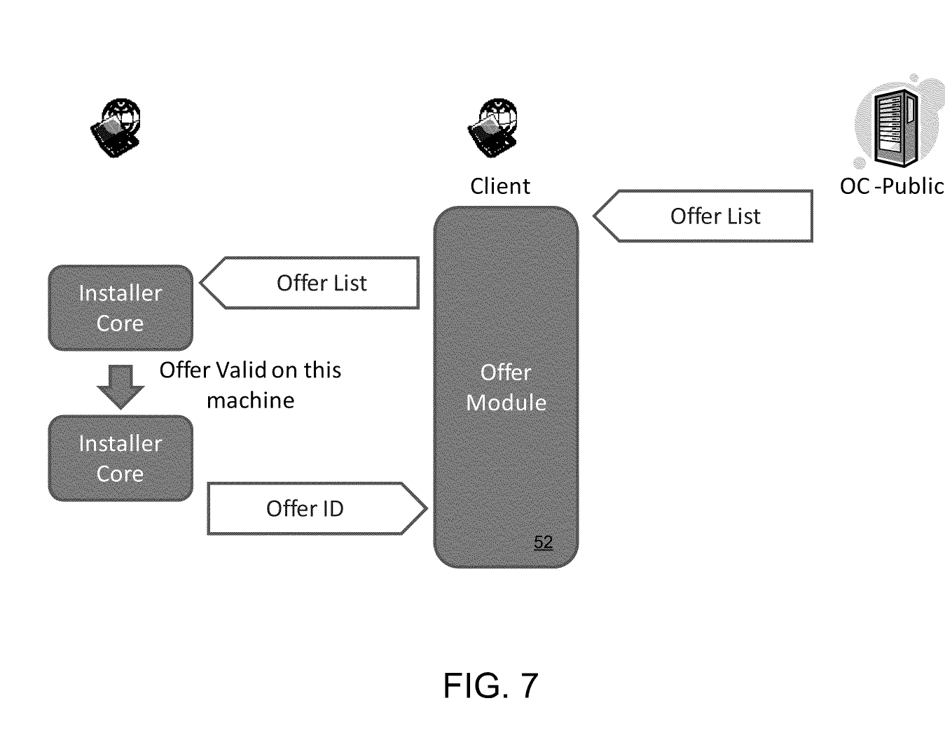

When a client application receives an offer or a list of offers from a server system in accordance with an embodiment of the invention, the client application can filter the offers to ascertain which of the offers are valid for the user device on which the client application is installed. An information flow associated with selection of offers that are valid for a specific user device is shown in FIG. 7. The information flow involves receipt of an offer list from a server system by a client application. The offer module 52 ascertains which of the offers are valid for the user device and filters the offers that are provided to the user accordingly. In many embodiments, the user is provided with a single offer. In several embodiments, the user is provided with multiple offers. The offers can be presented serially and/or simultaneously.

When a client application is filtering one or more offers, the client application often inspects that an operating system and/or supported features that are required to fulfill an offer (such as a software installation) are present on the user device. Client applications can also check to see whether the offer has already been accepted or the user has no need for the offered good or service via inspection of a user device registry and/or simple API calls to relevant software applications or services. Many client applications check for supported language and/or country codes, a required offer location and previously expired trials. In several embodiments, client applications check for any readily accessible information that is indicative of a user's interest level in a particular offer. In many embodiments, the client application seeks to identify the offer that is most likely to appeal to a user in order to optimize the overall acceptance rate of offers presented to users. In several embodiments, advertisers pay varying amounts when different offers are presented and/or accepted and advertising networks seek to present users with offer(s) that are likely to result in the highest amount of revenue.

In a number of embodiments, the server system also uses information obtained from a client application such as target information and IP address (proxy for geographic location) to filter an offer list for offers that are likely to be of interest to a user.

Although the information flow shown in FIG. 7 is described with reference to a specific advertising system architecture, similar information flows can be coordinated using other architectures. For example, a similar information flow can be coordinated in a system that uses a different server system architecture such as an architecture where the various databases are hosted on separate internal servers and/or the databases are configured as a single database.

### Tracking of Advertising

Information such as the number of users to whom a particular offer was provided, the number of instances in which the offer was accepted and characteristics of the users that accepted the offer and/or the circumstances under which the offer was accepted can be valuable in the targeting of future offers. Advertising systems in accordance with embodiments of the invention can track information, including but not limited to, information collected by client applications concerning users and user devices, offers presented to users and offers accepted by users.

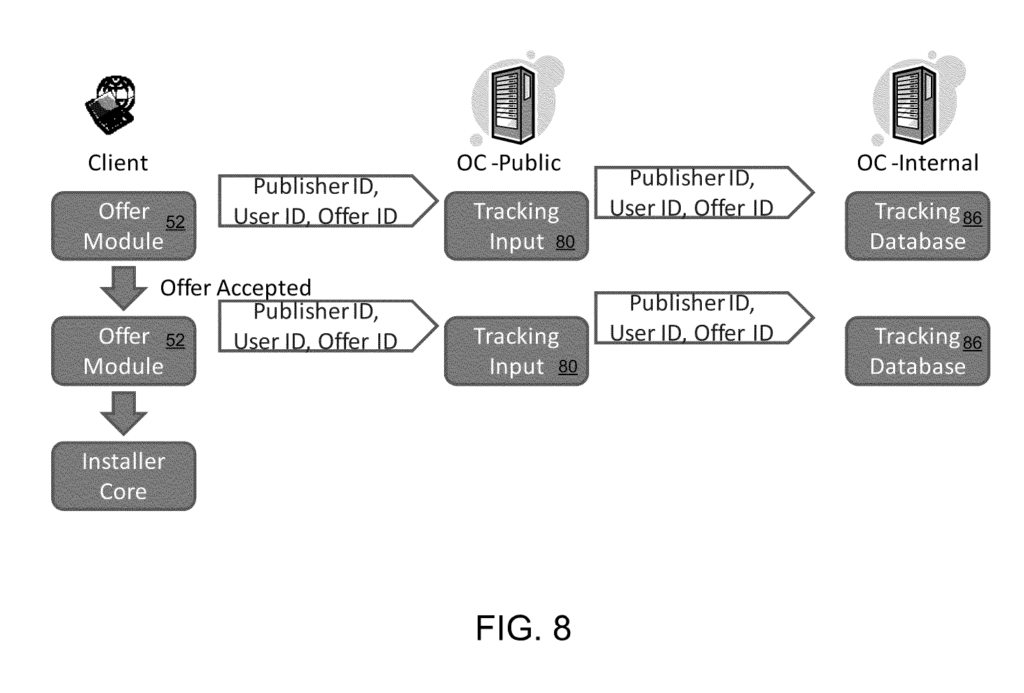

An information flow associated with the tracking of information by an advertising network in accordance with an embodiment of the invention is shown in FIG. 8. A client application collects target information and provides the information to a public facing server. In the illustrated embodiment, the offer module 52 of a client application provides information including a publisher ID, a user ID, and an offer ID of one or more offers presented to the user is provided to a public facing server. A tracking input module on the public facing server 80 provides the information to an internal server for storage in a tracking database. When an offer is accepted, the offer module 52 provides information including a publisher ID, a user ID and an offer ID of the accepted offer to the public facing server. The tracking input module 80 on the public facing server forwards the information to an internal server for storage in a tracking database. The information stored in the tracking database can be retrieved for calculating the effectiveness of offers and to assist in targeting new offers. In many instances, the information in the tracking database is also used to calculate, revenue generated by each publisher and the financial obligations of advertisers under advertising agreements as a result of the offers presented to users and offers accepted by users.

### Specific Applications

As discussed above, advertising networks in accordance with embodiments of the invention can be utilized in a variety of applications. A number of specific use cases are discussed below.

### Provision of Offers via a Personal Computer

In a number of embodiments, the advertising network provides offers via a user device, which is a personal computer (PC). Client applications are integrated into software installation and/or software update packages intended for the PC and/or its software payload. When the installation packages are executed, client applications collect data to enable server systems within the advertising network to determine which offers best fit the end-user and their PC. This data is transmitted to the server systems for analysis and offer determination The client applications then present the offer to the end user during the software installation or update process. If the user accepts the offer then any necessary software is downloaded or system configuration is performed in order to fulfill the offer. A transmission is sent to the server systems to indicate a successful offer acceptance along with information regarding which installation package initiated the offer process as well as other data which may include client application's analysis of the user's PC. The acceptance is recorded in the server system's databases.

### Provision of Offers via a Cell Phone

In applications where the advertising network provides offers to cell phone handsets, the client applications are integrated into the phone's firmware or delivered to the phone as part of an update or a subsequently installed piece of software. The client applications are triggered on the phone by a predetermined event such as software upgrade, cell network activation, first phone call, and/or other definable event. At the time of the client application activation, information regarding the phone, its operating environment and potentially user specific information are gathered and sent to a server system for analysis. The client data is analyzed and one or more offers are selected for the user. Applicable offers are presented to the user through the phone's graphical interface or via pre-programmed voice communications. If the user accepts the offer, then any necessary software is downloaded or system configuration is performed in order to fulfill the offer. A transmission is sent to the server system to indicate a successful offer acceptance along with information regarding which installation package initiated the offer process as well as other data, which may include client application's analysis of the user device. The acceptance is recorded in the server system's databases.

### Provision of Offers via a Set Top Box Connected to a Television

In applications where the user device is a set top box connected to a television, the client applications are embedded into the set top box's firmware. When a program or movie is viewed through the set top box, viewing history (complete, recent, current media only, user specific, or other permutations) is transmitted to a server system for analysis. At some pre-selected event such as the end of a piece of media or the premature termination of a piece of media, an offer or list of offers is retrieved from the server system for presentation to the end user. The offers may include other media the user may be interested in, a service related to the user's interests, or simply viewable advertising used to sponsor/monetize a piece of content. If the offer is accepted, the acceptance is communicated to the server system for recording into system databases. In addition, any necessary software and/or media is transmitted or replayed to fulfill the offer.

While the above description contains many specific embodiments of the invention, these should not be construed as limitations on the scope of the invention, but rather as an example of one embodiment thereof. For example, many of the embodiments described above involve the presentation of an offer that is related to the user device executing the client application. In many embodiments, the client application is executed on a first user device and the offer involves an action related to a second user device. By way of example, an installer package on a personal computer can present an offer involving the downloading of an application to a mobile phone handset. Accordingly, the scope of the invention should be determined not by the embodiments illustrated, but by the appended claims and their equivalents.

What is claimed is:

1. An advertising network, comprising:
a user device connected to a network;
an advertising server system connected to the network, where the advertising server system stores information concerning a plurality of offers;
a partner server connected to the network;
wherein the user device is configured to execute an installation package to perform a predetermined operation, where the execution of the installation package triggers execution of a client application configured to collect information concerning the user device and to forward the collected information to the advertising server system as the installation package performs the predetermined operation;
wherein the advertising server system is configured to select at least one of the plurality of offers based upon the collected information and to forward information concerning the at least one selected offer to the client application;
wherein the client application is configured to display via the user device information concerning the at least one selected offer as the installation package performs the predetermined operation; and
wherein the client application is configured to contact the partner server to obtain fulfillment of an accepted offer.

2. The advertising network of claim 1, wherein:
the installation package includes an installer, a payload application and the client application;
the predetermined operation includes the application of the payload application to the user device.

3. The advertising network of claim 2, wherein the client application is bundled in the installation package and the installer activates the client application via an adaptor.

4. The advertising network of claim 2, wherein the client application is integrated with the installer.

5. The advertising network of claim 2, wherein the client application is integrated with the payload application.

6. The advertising The advertising network of claim 2, further comprising:
a download server, where the installation package is stored;
wherein the user device downloads the installation package from the download server.

7. The advertising network of claim 1, wherein the predetermined operation includes a service signup.

8. The advertising network of claim 1, wherein the predetermined operation is the display of media.

9. The advertising network of claim 1, wherein the information collected by the client application includes data descriptive of the user device.

10. The advertising network of claim 9, wherein the information collected by the application includes information concerning at least one of the capabilities of the device, the configuration of the device, software present on the device, software absent from the device, device operating system type, and device operating system configuration.

11. The advertising network of claim 1, wherein the information collected by the client application also includes data descriptive of the user of the user device.

12. The advertising network of claim 11, wherein the information collected by the application includes at least one of user language setting, user identification, and services available to the user

13. The advertising network of claim 1, wherein the information collected by the client application includes the geographic location of the user device.

14. The advertising network of claim 1, wherein:
the installation package includes validation information;
the client application is configured to provide the validation information to the advertising server system; and
the advertising server system is configured to verify the validation information before providing offers to the client application.

15. The advertising network of claim 14, wherein the validation information includes information identifying the publisher of the installation package.

16. The advertising network of claim 14, wherein the validation information includes a software signature.

17. The advertising network of claim 1, wherein:
the installation package includes information identifying the publisher of the installation package;
the advertising server system maintains an account with respect to the publisher of the installation package;
the client application is configured to provide the information identifying the publisher of the installation package to the advertising server system; and
the advertising server system credits the account of the publisher when an offer provided to the user device by the advertising server system is accepted.

18. The advertising network of claim 1, wherein the user device is a personal computer.

19. The advertising network of claim 1, wherein the user device is a mobile phone handset.

20. The advertising network of claim 19, wherein the client application is part of the firmware of the mobile phone handset.

21. The advertising network of claim 1, wherein the user device is a set top box connected to a display.

22. The advertising network of claim 21, wherein the client application is part of the firmware of the set top box.

23. The advertising network of claim 1, wherein the partner server is part of the advertising server system.

24. An advertising network, comprising:
a user device connected to a network;
a download server connected to the network, where the download server stores an installation package that contains an installer, a payload application, and a client application and the installation package is configured to install the payload application on the user device;
an advertising server system connected to the network, where the server system stores information concerning a plurality of offers;
a partner server connected to the network;
wherein the user device is configured to obtain the installation package from the download server and execute the installer to install the payload application;
wherein the installer is configured to execute the client application during the installation of the payload application;
wherein the client application is configured to forward the installation package validation information to the advertising server system;
wherein the advertising server system is configured to validate the installation package and identify the publisher of the installation package using the installation package validation information;
wherein the advertising server system is configured to select at least one of the plurality of offers and to forward information concerning the at least one selected offer to the client application;
wherein the client application is configured to display via the user device information concerning the at least one selected offer during the installation of the payload software application;
wherein the client application is configured to contact the partner server to obtain fulfillment of an accepted offer;
wherein the advertising server system is configured to update an account maintained concerning the publisher of the installation package to reflect the fulfillment of the accepted offer.

25. The advertising system of claim 24, wherein the partner server is part of the advertising server system.

26. The advertising system of claim 24, wherein the client application is bundled within the installation package and the installer activates the client application via an adaptor.

27. A method of presenting offers to a user during the installation of a payload application on a user device comprising:
downloading an installation package to a user device, where the installation package includes an installer, a payload application, and a client application;
executing the installer, where the installer applies the payload application to the user device and executes the client application;
forwarding installation package validation information to an advertising server system using the client application;
selecting at least one from a plurality offers stored on the advertising server system in response to the verification of the installation package validation information;
providing the at least one offer to the client application;
presenting the at least one offer to a user via the user device;
receiving acceptance of at least one of the offers via the user device; and
requesting fulfillment of the offer using the client application.

28. The method of claim 27, wherein the client application is bundled within the installation package and the installer activates the client application via an adaptor.

29. The method of claim 27, further comprising:
collecting information from the user device using the client application; and
forwarding the collected information to an advertising server system using the client application;
wherein the at least one of the plurality of offers is selected based upon the collected information.
